(19) United States
(12) Patent Application Publication
(10) Pub. No.: US 2013/0224720 A1
(43) Pub. Date: Aug. 29, 2013

(54) METHODS AND APPARATUS FOR DYNAMIC TRAINING AND FEEDBACK

(71) Applicant: PROVING GROUND LLC, (US)

(72) Inventor: Sean Kearns, Fountain Hills, AZ (US)

(21) Appl. No.: 13/838,049

(22) Filed: Mar. 15, 2013

Related U.S. Application Data
(63) Continuation-in-part of application No. 13/345,501, filed on Jan. 6, 2012.
(60) Provisional application No. 61/617,863, filed on Mar. 30, 2012.

(51) Int. Cl. G09B 7/00

(52) U.S. Cl. CPC G09B 7/00
USPC 434/362

(57) ABSTRACT

Methods and apparatus for dynamic training and feedback according to various aspects of the present invention generally comprise administering training material to a user in conjunction with one or more icons associated with a skill the training material is intended to develop, tracking the progress of a user through the training material, and representing the tracked progress using the one or more icons. The training material may be administered in conjunction with an interactive feature to facilitate collaboration.

### CROSS-REFERENCES TO RELATED APPLICATIONS

This application is a continuation-in-part of U.S. patent application Ser. No. 13/345,501, filed on Jan. 6, 2012, entitled METHODS AND APPARATUS FOR DYNAMIC TRAINING; claims the benefit of U.S. Provisional Patent Application No. 61/617,863, filed Mar. 30, 2012, entitled METHODS AND APPARATUS FOR DYNAMIC TRAINING AND FEEDBACK; claims the benefit of U.S. Provisional Patent Application No. 61/646,485, filed May 14, 2012, entitled METHODS AND APPARATUS FOR LEARNING; and incorporates the disclosure of each application by reference.

### BACKGROUND OF THE INVENTION

Classroom training, one-on-one coaching, seminars, best-practices discussions, and traditional studying have been the primary methods of providing education and training. Each of these traditional methods, although somewhat effective, fails to provide an efficient way to achieve the context-specific repetition and application necessary for developing long-term memories and skills. The progress of a trainee participating in a traditional method of learning is usually measured subjectively, and objective measures of progress are difficult to obtain. Further, the traditional methods are not conducive to monitoring the progress of a group of trainees if the trainees participate in multiple courses of varying topics, or to presenting the progress of multiple trainees in an easily-understandable format.

### SUMMARY OF THE INVENTION

Methods and apparatus for dynamic training according to various aspects of the present invention may comprise administering training material to a user in conjunction with one or more icons, and representing the user's progress using the one or more icons. Each icon may represent a skill the training material is intended to develop. The icon may be substantially optimized to increase a user's training participation and/or increase a user's retention of the training material. Administering training material to a user may comprise presenting an interactive feature to the user.

### BRIEF DESCRIPTION OF THE DRAWING FIGURES

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a training system;

FIG. 2 is a block diagram of a client system;

FIG. 3A is a block diagram representing a client system running the training system;

FIG. 3B is a block diagram representing a client system running a training system that utilizes a content database located a remote server;

FIG. 3C is a block diagram representing a client system running an application that accesses the training system that utilizes a content database located a remote server;

FIG. 4 representatively illustrates a visual layout of testing system;

FIG. 5 representatively illustrates a visual layout of the testing system including an interactive feature;

FIG. 6 representatively illustrates an interactive summary window;

FIGS. 7A and 7B representatively illustrate visual layouts of the testing system including icons;

FIG. 8 representatively illustrates a presentation of training progress;

FIGS. 9A-9E representatively illustrate an icon associated with a skill to be developed;

FIG. 10 representatively illustrates a group of icons;

FIG. 11 representatively illustrates a group of icons representing that certification is complete for a training course; and

FIG. 12 representatively illustrates a skyline view comprising multiple groups of icons arranged according to topic.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of hardware or software components configured to perform the specified functions and achieve the various results. For example, the present invention may employ systems, technologies, algorithms, designs, and the like, which may carry out a variety of functions. In addition, the present invention may be practiced in conjunction with any number of hardware and software applications and environments, and the system described is merely one exemplary application for the invention. Software and/or software elements according to various aspects of the present invention may be implemented with any programming or scripting language or standard, such as, for example, HL7, AJAX, C, C++, Java, COBOL, assembly, PERL, eXtensible Markup Language (XML), PHP, etc., or any other programming and/or scripting language, whether now known or later developed.

The present invention may also involve multiple programs, functions, computers and/or servers. While the exemplary embodiments are described in conjunction with conventional computers, the various elements and processes may be implemented in hardware, software, or a combination of hardware, software, and other systems. Further, the present invention may employ any number of conventional techniques for presenting training material, testing training participants, rendering content, displaying objects, communicating information, interacting with a user, gathering data, managing training programs, usage tracking, calculating statistics, and the like.

For the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Methods and apparatus for dynamic training and feedback according to various aspects of the present invention may operate in conjunction with any suitable display, computing process or machine, interactive system, and/or testing environment. Various representative implementations of the present invention may be applied to any system for optimizing, displaying, coordinating, and tracking the training material and the use thereof. Certain representative implementations may comprise, for example, methods or systems for presenting training material on a display device.

A training system may comprise a system designed to provide a user with relevant training material, simulators, and testing devices designed to help the user learn information, learn or improve skills, develop concepts, engage in job training, and the like. The training system may also provide a system for allowing the user to access training material, a simulator for practicing learned skills, and a testing system to demonstrate proficiency with the learned skills. Skills may also be referred to as habits or behaviors. The training system may further be adapted to divide users into one or more groups based upon any relevant factor such as teams, geographic location, region, district, supervising manager, company divisions, job type, job code, company, and the like. Training programs may be customized based upon a particular group's needs. Methods and apparatus according to various aspects of the present invention may provide an objective measure of a user's progress through the training material.

An administrator, such as an employer or a teacher, may elect to require a training course. The administrator may select the various training material for that course. For example, the administrator may require a training course on a new sales technique. The training material may comprise a general description of the sales technique, how and when to implement the sales technique, case studies that test a user's mastery of the new technique, and one or more skills associated therewith. The administrator may select the various parameters of how the training will take place. For example, the administrator may require the course to be completed in a certain amount of time and/or the minimum score the user must achieve to pass the course. The training material may be divided into various sections and questions, case studies, answers, and explanations may be created.

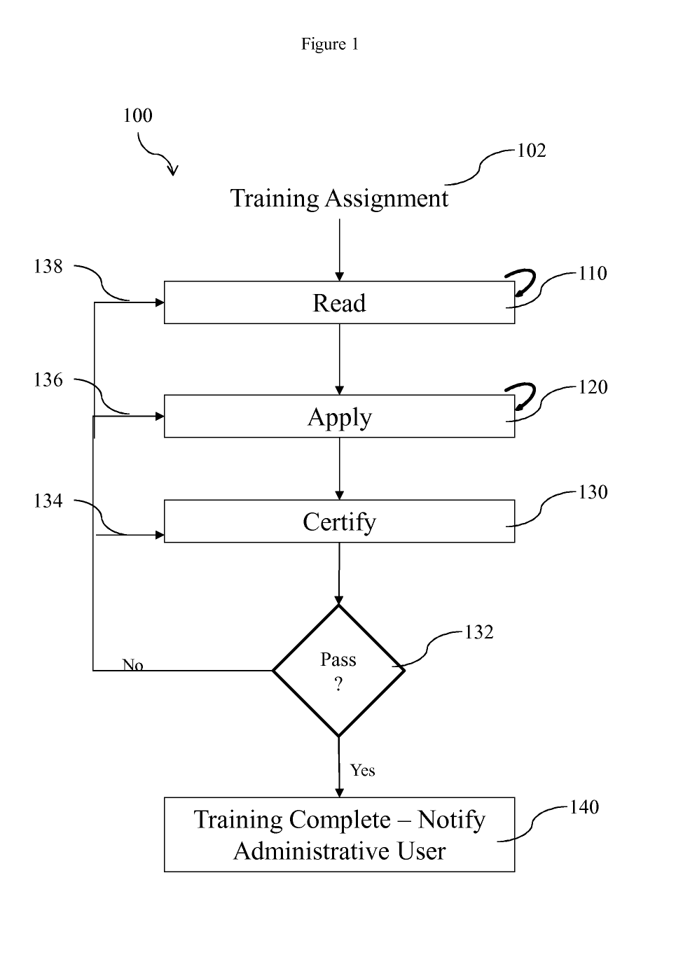

For example, referring to FIG. 1, the training system 100 may comprise a read section 110, an apply section 120, and a certify section 130. The training material for each section may be selected and/or created by the administrator. The training material may correspond to a particular training course to be administered to one or more users. After the user has been assigned a training assignment 102, the user may start the training by entering and completing the read section 110. Upon the completion of the read section 110, the user may elect whether to continue reviewing the material in the read section 110 or continue onto the apply section 120. After completing the apply section 120, the user may elect whether to continue working in the apply section 120 or may move on to the certify section 130. If the user passes the certify section 130 (132), then the training is deemed complete and the administrator may be notified 140. If the user does not pass the certify section 130 (132), the user may attempt the certify section 130 again (134), or may return to one of the previous sections (136, 138). Administering the training material may comprise presenting the training material to the user in the read section 110, apply section 120, and/or certify section 130.

In one embodiment, the training system 100 may be remotely accessed by the administrator. The administrator may view the user's progress through the various sections as well as the user's performance. In one embodiment, the administrator may also adjust parameters, such as adjusting deadlines and required scores for passing certification 130. The administrator may also adjust the training material by adding new material, deleting material, and/or editing material.

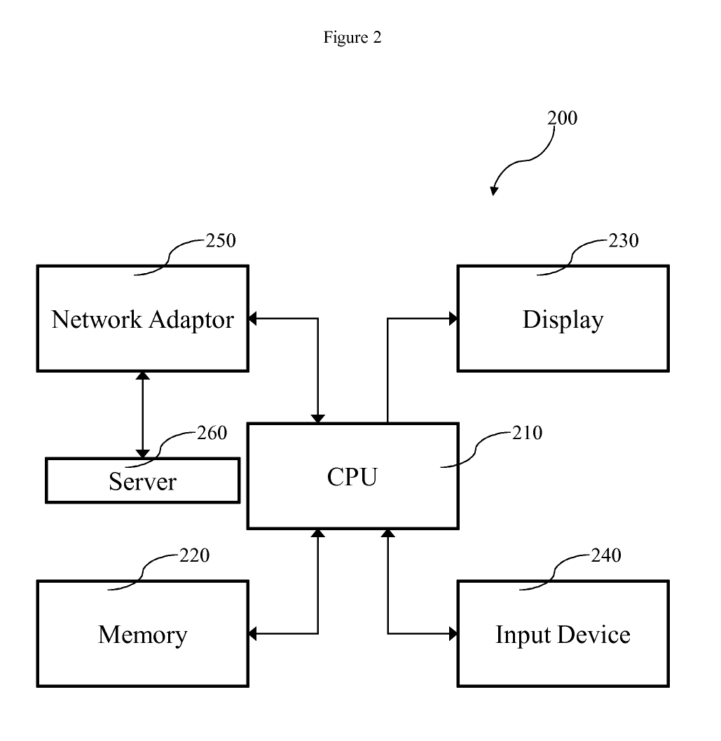

The training system 100 may be configured to be accessed by, or run on, a client system. The client system may comprise any suitable client system such as a personal computer, a smart-phone, a tablet computer, a television, an e-reader, and the like. The client system may be configured to access and display the training system 100, as well as accept input from a user. For example, referring to FIG. 2, the client system 200 may comprise a CPU 210, a memory device 220, a display 230, and an input device 240. The training system 100 may be stored in the memory device 220, while the CPU 210 may be configured to access and write to the memory device 220. The CPU 210 may also be configured to provide the display 230 with content from the training system 100 and to receive input from the input device 240. In one embodiment, the input device 240 may be integrated into the display 230, such as in a touch screen display.

In another embodiment, the client system 200 may further comprise a network adaptor 250 that allows the CPU 210 to connect to a remote server 260. The server 260 may comprise a conventional computer server comprising a CPU 210, memory device 220, and network adaptor 250. Thus, the training material may be stored on the server 260 in a user accessible memory device 220 regardless of the memory being located on the client system 200 or on the server 260.

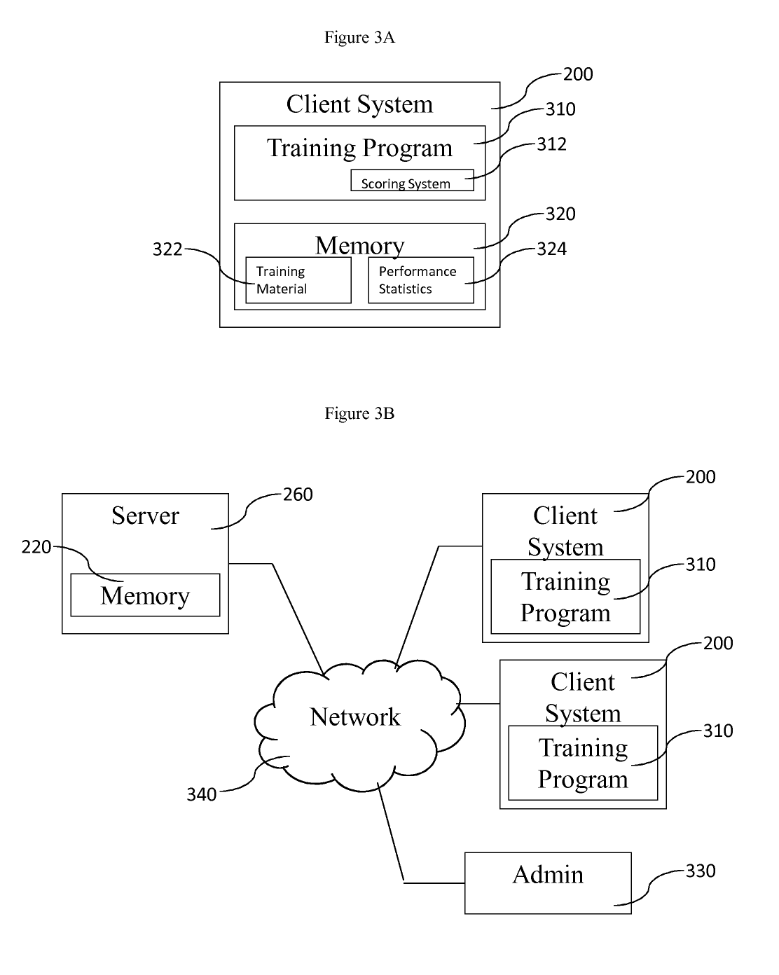

The training system 100 may be divided into separate operating components. For example, referring to FIG. 3A, in one embodiment, the client system 200 may run a training program 310 and operate a memory 320 that contains the training material 322. In one embodiment, the memory 320 may comprise a database. Referring now to FIG. 3B, in another embodiment, the memory 320 may be located on the server 260. The server 260 may be accessible via a network 340. The server may be located on a local intranet or on the internet. The training program 310 and the memory 320 may be configured to work seamlessly over the network 340. The network 340 may be a direct network connection, a local intranet connection, a wireless network connection, an internet connection, and the like. An administrator 330 may also be connected to the network 340 and able to connect to the client systems 200 and server 260.

The training system 100 may also be configured to keep track of the user's progression through the training system 100 and user performance statistics 324 using a scoring system 312. The scoring system 312 may operate within the training program 310 and modify the performance statistics 324 as the user progresses through the training material 322. The performance statistics 324 may be stored in the memory 320. The training program 310 may update the scoring system 312 based on whether a selected answer was correct or incorrect. The performance statistics 324 may comprise the number of questions the user has answered, the number of questions correctly answered, the amount of time spent using the training system 100, the amount of time spent in each section, the number of times the certify section 130 was attempted, and any other relevant statistics. The performance statistics 324 and the user's progression through the training material 322 may be accessed by the user and/or by an administrator.

Referring to FIG. 3C, the training system 100 may be configured to run on the server 260 and be accessed by and communicate with the client system 200 via an application 350. In one embodiment, the application 350 may comprise an internet browser such as Internet Explorer, Safari, Firefox, Opera, or Chrome etc. In another embodiment, the application 350 may comprise a client system specific application. For example, the application may comprise a native OS application designed to run natively on an operating system such as iOS, Android, Windows, Windows Phone, Symbian OS, Blackberry OS, webOS, Mac OS, Linux, Unix, or any other operating system. The application 350 may also be a cross platform application, such as a Java or Adobe Flash application. The application 350 may display the various elements of the training system 100 and accept user inputs, while training system 100 is operating remotely on the server 260. Thus, the server 260 may receive the user inputs and supply the application 350 with the corresponding information to be displayed.

User input for selecting an answer option or accessing a program menu may be allowed in any manner facilitated by the device that is being used. For example, on a personal computer, the training program 310 may be designed to accept both keyboard and mouse input. In another example, on a touchscreen device such as a tablet computer or smartphone, the training program may be configured to receive a touchscreen input.

The training system 100 may be installed on one or more client systems. For example, if the training system 100 operates solely on the client system 200, then the training system 100 may be installed in a manner similar to a conventional computer program or hardcoded into the machine. If the training system 100 is implemented across multiple computers, such as with the client system 200 and the server 260, then relevant elements of the training system 100 may be installed on the server 260. Additional elements may be implemented by the client system 200, or the client system 200 may operate merely as a terminal, for example if the client system 200 is utilizing an internet browser to interface with the training system 100 that is operating on the server 260. If the application 350 comprises a native OS application, then the native OS application may be installed on the client system 200.

The user may begin training by starting the read section 110. The read section 110 may comprise bulk material for consumption by the user. The training system 100 may require that the read section may be presented to the user before the apply 120 and certify 130 sections can be accessed. The bulk material may comprise material designed to convey the training material 322 to the user and may include rules, guidelines, essays, reports, charts graphs, diagrams, or any other means of conveying the training material 322. The read section 110 may also be available at any time for the user to use as reference material.

For example, the read section 110 may include information relating to a new sales protocol. In this example, the read section 110 may comprise an outline of the sales protocol itself, instructions on situations where the sales protocol should be used, diagrams conveying the effectiveness of the sales protocol in those situations, and information relating to how to identify a situation where the sales protocol should be used. The read section 110 may also provide a user with a lecture with the information, and/or may include video of the sales protocol being used. In other words, the read section 110 may provide the user with the training material 322, but may not actively require the user to apply the training material 322.

The apply section 120 may simulate situations that require the application of the training material 322. The training material 322 may comprise testing content. The apply section 120 may be configured as a case study based teaching system comprising testing content and a scoring system. The testing content may comprise multiple case studies, questions based on the cases studies, potential answers to the questions, and explanations of the best answers for each question. In addition, each potential answer and answer explanation may correspond to a particular skill presented or otherwise developed by the training material, each skill may be associated with an icon, and the training material 322 and/or testing content may comprise one or more icons. The scoring system may track any relevant performance statistics 324, such as the user's correct and incorrect responses, progression through the testing content and/or training material 322, and may also determine and track a user score.

In one embodiment, the apply section 120 may present the user with a case study to evaluate. In addition to the case study, the apply section 120 may also present the user with a question prompt and potential answers. A potential answer may comprise text and/or one or more associated icons. Each of the potential answers may be selectable. In the embodiments wherein a potential answer comprises text and an icon, the text and/or the icon may be selectable. The apply section 120 may also present the user with an answer confirmation button to confirm that a selected answer is the user's final answer.

The user may select a potential answer from the list of potential answers and then select the answer confirmation button to confirm the selection and move forward. The apply section 120 may then evaluate the selection to determine if the best or correct answer was selected. The apply section 120 may then notify the user whether the correct answer was selected and offer an explanation as to why the answer is correct. The apply section 120 may also provide the user with an explanation as to why an incorrect answer is either incorrect or not the best answer. The apply section 120 may present an icon associated with a skill discussed by the explanation. The apply section 120 may also present the user with an advance button that the user may use to indicate that they are ready to move on to the next problem.

As each case study is evaluated and answered, the training system 100 may keep track of performance statistics 324. The performance statistics 324 may comprise any relevant performance statistics 324 including, the number of questions attempted, the number of questions answered correctly, the amount of time spent on each question, any other relevant performance information, and/or any relevant information corresponding to a user's progress through the training material.

The certify section 130 may test the user's mastery of the training material 322. In one embodiment, the certify section 130 may comprise a case study based multiple choice test, and may comprise and/or use one or more icons. The case study based multiple choice test may be formatted with a case study, a question prompt, and potential answers, similar to the case study based teaching system of the apply section 120, but may not provide the user with answer explanations or immediate feedback. The multiple choice test may be of sufficient length to test the user's mastery of the training material 322. If the user answers enough of the questions correctly, the user may be certified for the training material 322.

The testing content may comprise any suitable content for teaching the training material 322 and may be configured in any suitable format. For example, the testing content may comprise the case study, the question prompt, potential answers, answer explanations, and icons associated with the skills corresponding to the answer explanations. The case study may provide a series of facts and or situations that are directed towards simulating situations and complex problems that the user will potentially encounter in the future, causing the user to simulate the decision making required in those situations. The question prompt may then ask a question or ask for a best course of action for the given situation or facts. The potential answers may be displayed and may include a series of possible courses of action or responses, and icons associated therewith. Depending on the answer selected, an answer explanation and/or an associated icon may be displayed and a score may be determined and recorded to the performance statistics 324. The user may then move on to the next case study.

The testing content may be supplied by any suitable source. For example, the testing content may be generated by a third party from training material 322 supplied by a user, administrator, and/or a by the third party. In another embodiment, the testing content may be modified by the administrator. The training material 322 comprises the testing content.

A case study may comprise fact patterns, statements, quotes, conversations, events, decisions, projects, policies, and/or rules that may be analyzed by the user to determine a correct response or course of action. The case study may offer enough information to perform an in-depth examination of a single event or case. The case study may comprise information that is relevant to the training material 322 and may include field-of-study related situations. Thus, the case studies may be configured to provide the user with repeated exposure to relevant situations for the user to learn the training material 322 and/or develop relevant skills.

The question prompt may be any relevant question with regard to the case study. In one embodiment, the question prompt may be configured to simulate a real world decision making process. For example, the question prompt may ask a user for the most appropriate response to a query from a customer, the question prompt may ask the user to pick an option that best describes the situation, or the question prompt may ask the user to pick a best course of action.

The potential answers may comprise a plurality of multiple choice answers that may or may not be relevant to the question prompt and/or fact pattern. The potential answers may be located in any suitable location relative to the question prompt. The potential answers may each be user selectable and de-selectable. A potential answer may comprise text and/or one or more icons. In the embodiments wherein a potential answer comprises text and an icon, the icon may be located in any suitable location relative to the text.

The confirmation button may be configured to allow the user to confirm that the selected answer and/or icon is the user's answer and that the user is ready to move on. Once the confirmation button is selected, the user's answer selection may be graded and scored and the feedback may be displayed.

The testing content may comprise answer explanations for each potential answer and may be used to convey the training material 322. The user may select an answer to a proposed question regarding a case study and the apply section 120 may provide the user feedback regarding whether the selected answer was correct or incorrect and why an answer is a best answer. The feedback may comprise text and/or one or more icons.

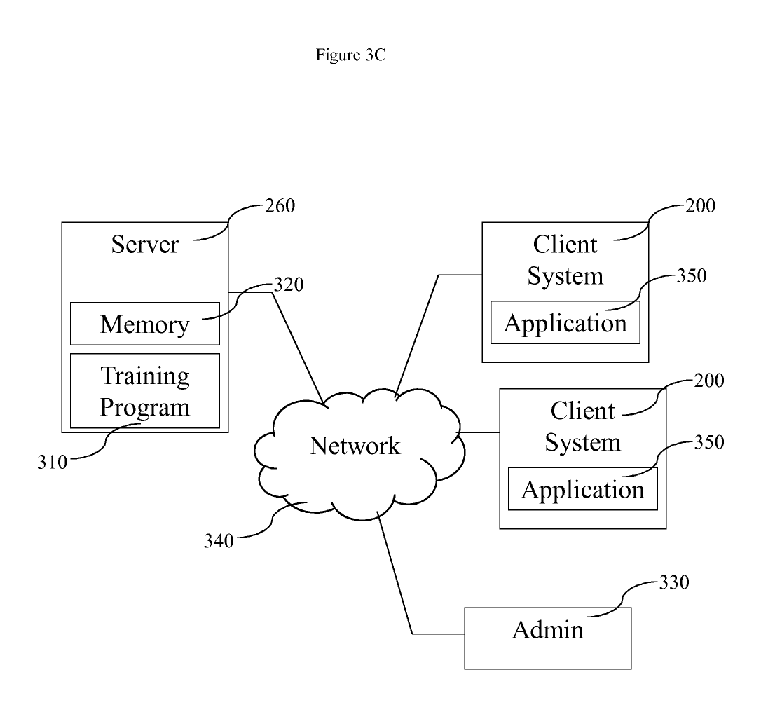

Referring to FIG. 4, a testing window 400 may run on a client system 200 and be configured to display a case study window 410, an explanation window 420, and a menu 430. The case study window 410 may be configured to display a relevant case study 411, a question 412 regarding the case study 411, potential answers 413, 414, 415, 416, and a confirmation button 417. A potential answer may comprise an associated icon. Any number of potential answers may be displayed. Once one of potential answers 413, 414, 415, 416 has been selected, the confirmation button 417 may be selected, and the explanation window 420 may be activated to reveal an answer indicator 421 and an explanation 422. The explanation window may comprise an icon associated with the explanation 422. In one embodiment, the explanation window 120 may also include alternative explanations 423, 424, 425 that may be selected to provide reasoning as to why each of the incorrect multiple choice answers are not the best answer. The menu 430 may be configured as a drop-down menu.

The case study window 410 may be configured to display the case study 411, the question 412, the multiple choice answers 413, 414, 415, 416, and the confirmation button 417. The case study window 410 may be arranged in any suitable way to facilitate displaying the case study 411 and the multiple choice answers 413, 414, 415, 416. For example, the case study window 410 may be arranged with the question 412 displayed at the top of the case study window 410, the multiple choice answers 413, 414, 415, 416 in the middle of the case study window 410, and the case study 411 at the bottom of the case study window 410. The case study window 410 may be arranged differently for different case studies 411.

The explanation window 420 may be configured to appear after the user has selected one of the multiple choice answers 413, 414, 415, 416 and has confirmed that selection using the confirmation button 417. The explanation window 420 may display whether the user selected the correct answer using the answer indicator 421. The explanation window 420 may comprise an explanation 422 describing the correct answer for the case study. The explanation window 420 may comprise an icon associated with the explanation. In one embodiment, the explanation window 420 may include alternative explanations 423, 424, 425 that may be selected. The alternative explanation 423, 424, 425 may explain why the corresponding incorrect answers were incorrect.

The drop down menu 430 may be positioned at the top of the testing window 100. The drop down menu 430 may be configured to display performance statistics 324. The performance statistics 324 may be broken down into scoring information for various types of testing content. The performance statistics 324 may be based on any relevant scoring factors for the given testing content. For example, the performance statistics 324 may include raw scores, time spent, percentage of correct answers, percentage of questions answered, time remaining, progress through testing content and/or training material 322, or any other relevant scoring information. The scoring information may be broken down between various subjects, topics, training courses, or any other relevant grouping. The scoring factors may include correct answers, time spent on a case study, or any other scoring factor that is suitable for the testing content.

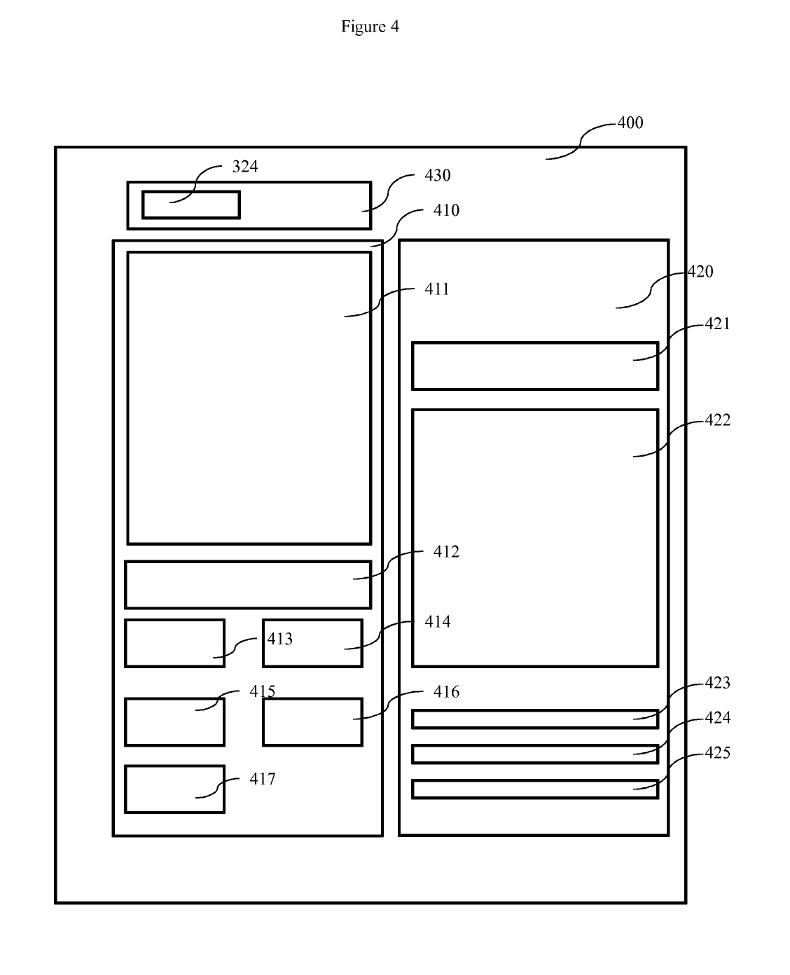

Referring to FIG. 5, in some embodiments, the testing window 400 may comprise an interactive feature 505 that allows the user to respond to and/or gather additional information concerning a particular question/answer combination relating to a training program. For example, in one embodiment the interactive feature 505 may comprise an interactive comment tool that allows a user to add a comment to a given question and answer combination. The user comment may then be provided to a training center responsible for the training program as a method for improving the training materials. In another embodiment, to facilitate group learning, motivation, and information retention, the user may have the option of directing the comment to a common board for other users to see and/or respond to. The interactive feature 505 may comprise one or more buttons 510, 512, 514 that allow the user to achieve any or all of the above functions, and may comprise an area to enter text 520.

The training system 100 may also be configured to facilitate collaboration among users to improve comprehension and retention of the training material 322 and/or the development of relevant skills. For example, users associated with a given group may have the same training assignment 102 or may be required to progress through the same training material 322, practice skills associated with the training assignment 102 or training material 322, and successfully pass a certification 130 to demonstrate proficiency with the material covered. Users may be able to utilize the interactive feature 505 to collaboratively discuss test questions, answers to test questions, case studies, simulations, the reasoning why a particular answer is correct, and the like. The interactive feature 505 may encourage discussion and cooperation among the users in the group to facilitate a better overall comprehension of the training material 322 by the group as a whole. The interactive feature may also increase the users' motivation to progress through the assignment 102 or training material 322.

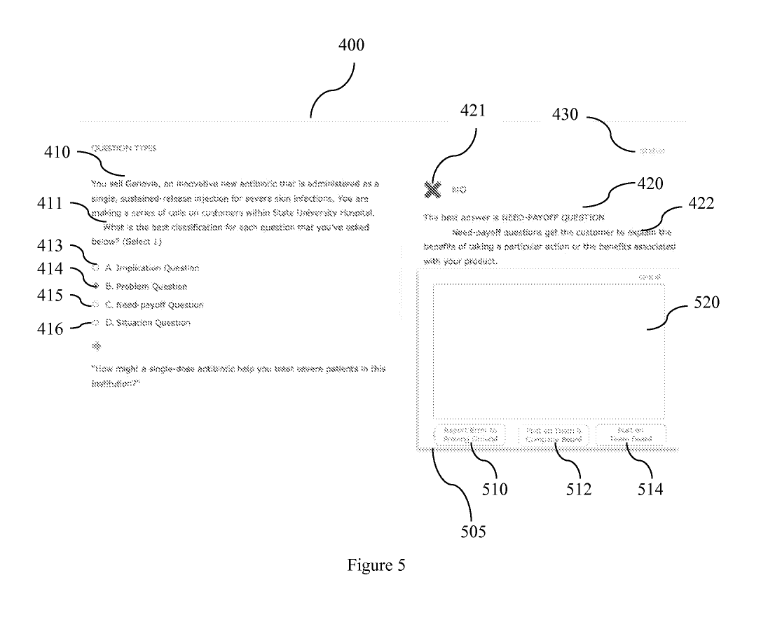

User comments and/or discussions submitted using the interactive feature 505 may be categorized by the training system 100 to facilitate communication between users on specific topics such as study area, case study, skill, simulation, test question, and the like. User comments and/or discussions submitted using the interactive feature 505 may be displayed to any appropriate user of the testing system 100. For example, referring to FIG. 6, the testing system may present an interactive summary window 605 providing a summary 610 of required job tasks 615 that must be completed by a user. The summary 610 may provide a breakdown of the tasks 615 and the level of completion for each task by the user, team, and/or group. The user may be able to access and/or take part in discussions associated with a particular task by clicking on the desired task 615. For example, by clicking on, or otherwise selecting a given task 615, the user may be presented with a comment window 620 containing comments from one or more users concerning the task 615 and/or discussions between users regarding the task 615. The user may be able to view comments and discussions, and may be able to actively take part in a discussion by adding their own thoughts, perspectives, experiences, and the like.

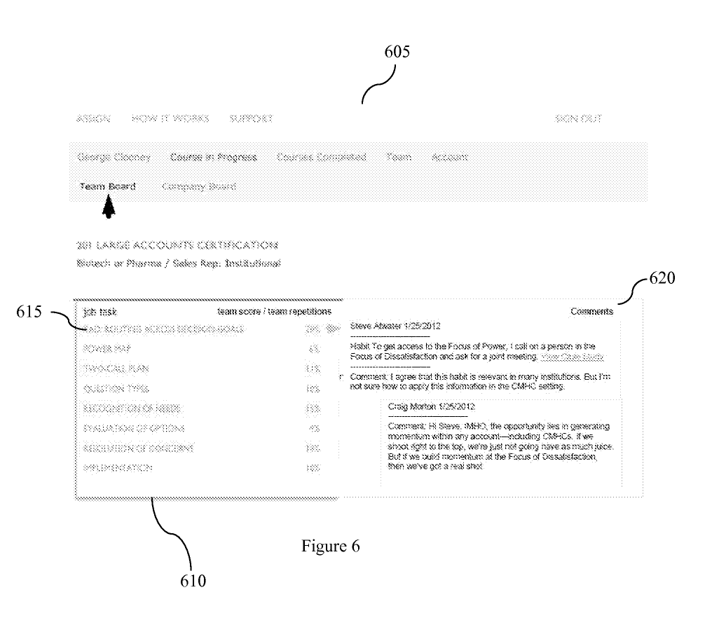

Referring to FIGS. 7A and 7B, an icon 702, 704, 706, 708, 710 may comprise any suitable graphic for representing a skill to be developed by the training material 322. For example, the icon may comprise a picture, a sound, an animation, or a video. The icon may facilitate a user's understanding or recognition of the associated skill. The icon may help increase the speed at which a user understands an explanation and/or recognizes when to apply a certain skill, such as when the user can quickly view and understand a series of icons instead of reading a written explanation. By increasing speed, the user may review more case studies in a given period of time. By increasing the number of case studies analyzed by the user, content retention and/or proficiency applying the related skill may be increased.

The icons may be activated or deactivated in any suitable manner for the device that the training system is operating on, and may be configured to be controlled by the administrator, user, and or other relevant personnel. In one embodiment, the icons may be enabled or disabled solely by an administrator. In another embodiment, the administrator may elect to enable or disable the icons, or the user may be permitted to enable or disable the icons. When icons are activated or deactivated, the training system 100 may automatically adjust the presentation of the testing content and/or training material 322 accordingly.

Referring again to FIGS. 7A and 7B, in some embodiments, multiple icons 702, 704, 706, 708, 710 may be utilized. One or more of the icons 702, 704, 706, 708 may be placed in the case study window 410, and one or more of the icons 710 may be placed in the explanation window 420. The one or more icons 710 in the explanation window 420 may be hidden until the answer indicator 421 and the explanation 422 are shown. The one or more icons 710 in the explanation window 420 may be utilized to convey a skill that is required to be applied to answer the question 412 correctly. The one or more icons 710 in the explanation window 420 may correspond to at least one of the icons 702, 704, 706, 708 in the case study window 410. For example, one or more of the icons 706 in the case study window 410 may identify a skill that should be applied to arrive at the correct answer, and one or more of the icons 702, 704, 708 in the case study window 410 may identify a skill that is not as correct to apply. In some embodiments, the icons may be user selectable. For example, if one of the icons 710 in the explanation window is selected by the user, the portion of the case study 411 that corresponds to the skill associated with the selected icon 710 may become highlighted. The various icons may be presented in any suitable manner, and an icon may be placed at any suitable location in the testing window 400.

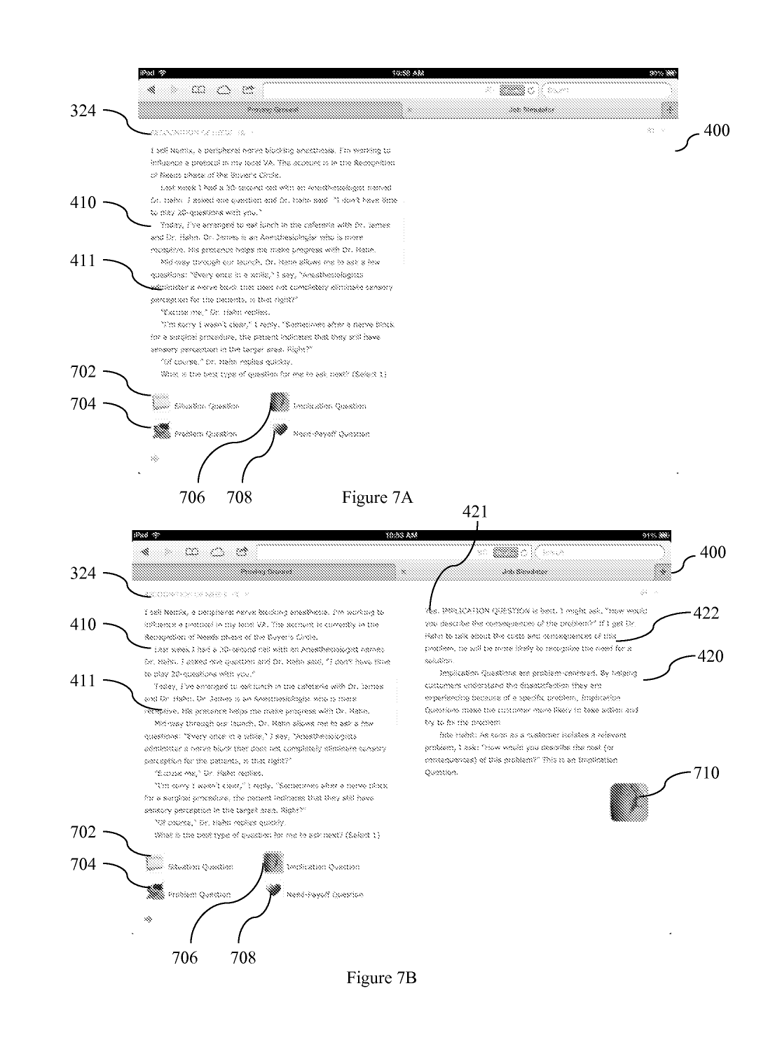

The training system 100 may further comprise a management module configured to allow the monitoring of progress of one or more users through various training programs and or training material 322. For example, referring now to FIG. 8, the management module may be adapted to display a listing of successful practice repetitions for one or more groups, individual users, locations, divisions, and the like. In one embodiment, a successful practice repetition may comprise a single correct answer to a test question. In this manner, the more correct practice repetitions accumulated by an individual or group, the higher the overall score displayed by the management module. The listing of successful practice repetitions may be displayed in any desired manner such as cumulative total of all successful practice repetitions achieved or on a rolling average such as daily, weekly, monthly, quarterly, or any other desired range.

The management module may be further adapted to display the progress or results in an interactive manner that allows for access to more detailed analysis. In one embodiment, each result 802 may comprise an interactive link to a detailed breakdown of the data used to generate the displayed value. For example, the user may be able to select a given result 802, such as one representing the number of successful practice repetitions for a team, and be presented with a detailed breakdown of the successful practice repetitions for each member of the team. Similarly, the user may then select a given team member and receive a detailed breakdown of the successful practice repetitions for that team member.

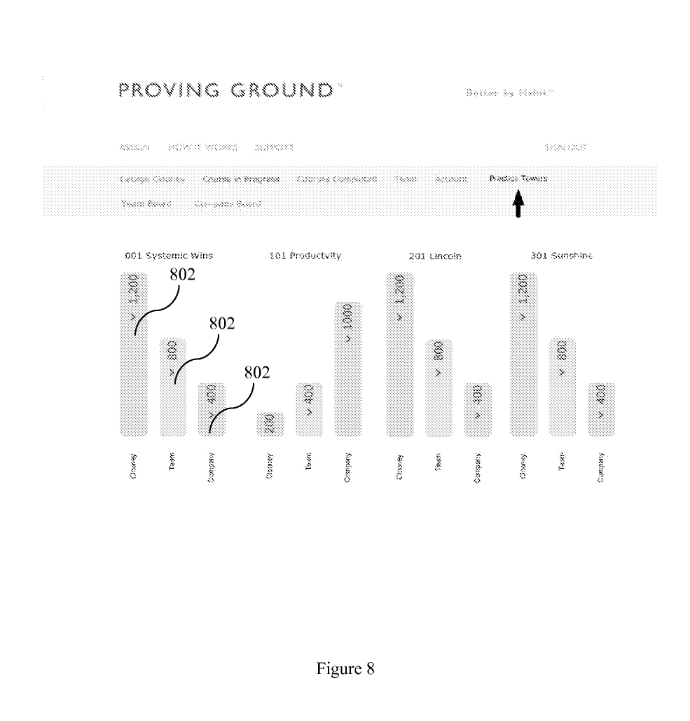

Referring to FIGS. 9A-9E, in an exemplary embodiment, the management module may be adapted to display a representation of progress using one or more icons. An icon may be associated with a skill presented in the training material 322. For example, an icon of a coffee mug 905 may be associated with the skill of writing a task list at the start of a work week.

The display of an icon may be created or altered by the management module to correspond to the progress of the user in correctly applying the associated skill. For example, if a user has never attempted to apply the associated skill, nothing may be displayed. Referring to FIG. 9A, if the user has attempted to apply the associated skill but has not yet applied the associated skill correctly, a dashed outline 910 may be displayed surrounding an area associated with the location of the icon. Referring to FIG. 9B, if the user has applied the associated skill correctly a small percentage of the time, such as 1% to 29%, the icon may be displayed with a low level of opacity, such as 15%. Referring to FIG. 9C, if the user has applied the associated skill correctly a medium percentage of the time, such as 30% to 59%, the icon may be displayed with a medium level of opacity, such as 50%. Referring to FIG. 9D, if the user has applied the associated skill correctly a high percentage of the time, such as 60% to 89%, the icon may be displayed with a high level of opacity, such as 100%. Referring to FIG. 9E, if the user has applied the associated skill correctly almost all of the time, such as more than 90% of the time, the icon may be displayed with a high level of opacity and the dashed outline 910 may be changed to a solid outline 915.

In some embodiments, the display of the icon described above may be created or altered based on how many times the user has attempted to apply the associated skill. For example, if the user has successfully applied the associated skill 100% of the time but has only attempted to apply the associated skill a small number of times, such as fewer than 10 attempts, the display may be altered based on how many times the user has attempted to apply the associated skill. In this example, if the user has successfully applied the associated skill one to three times out of the same number of attempts, the icon may be displayed as shown in FIG. 9B. If the user has successfully applied the associated skill four to six times out of the same number of attempts, the icon may be displayed as shown in FIG. 9C. If the user has successfully applied the associated skill seven to eight times out of the same number of attempts, the icon may be displayed as shown in FIG. 9D. If the user has successfully applied the associated skill nine times out of nine attempts, the icon may be displayed as shown in FIG. 9E. Other representations of progress may be used, such as altering the amount of coffee in the coffee mug icon 905.

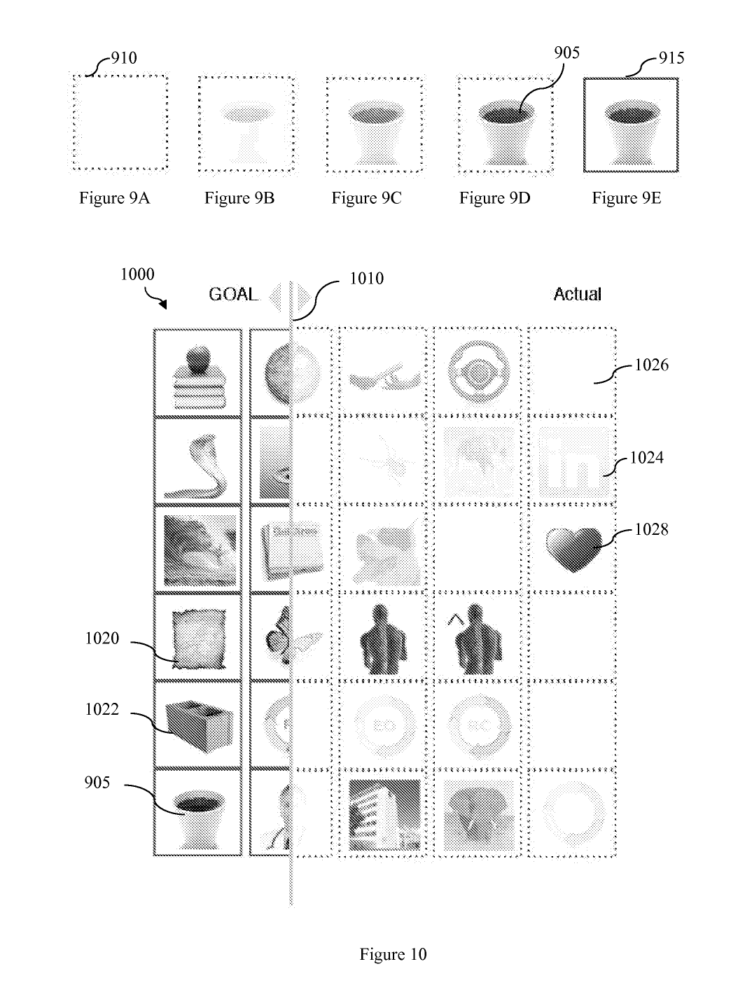

Referring to FIG. 10, the management module may be configured to display a group of icons 1000, wherein each icon in the group is associated with a skill to be developed by the training material 322. For example, a particular group of icons 1000 may be associated with the skills to be developed by a particular training course. Each icon in the group of icons 1000 may be displayed according to the progress of the user in applying the skill associated with the icon. For example, one or more icons 1026 may not be displayed if the user has not successfully applied the associated skill, and one or more icons 1024, 1028 may be displayed with varying levels of opacity based on the progress of the user in applying the associated skill.

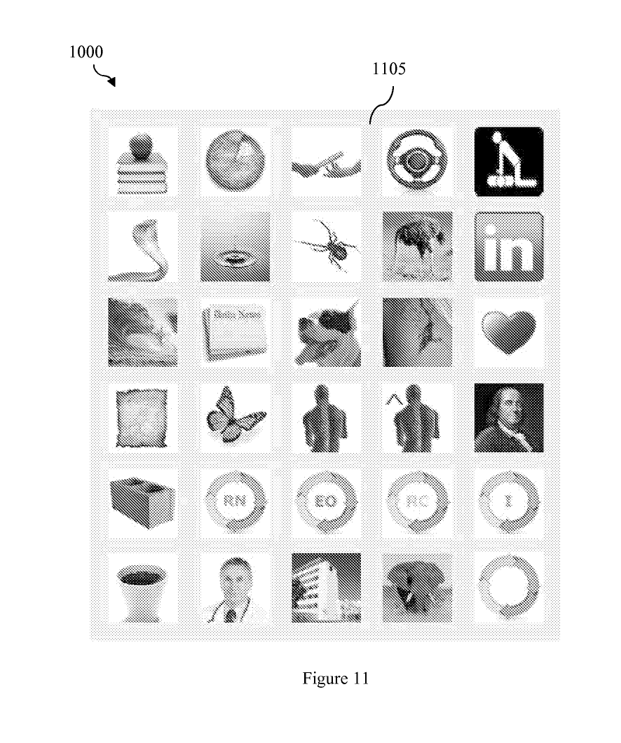

Referring to FIG. 11, the management module may be configured to create or alter the representation of progress based on a certification. For example, the display of the group of icons 1000 may be altered when a user whom the group of icons 1000 corresponds to completes the certify step 130 or otherwise completes or passes the particular course. The display may be altered by removing the borders 910, 915 surrounding each icon and placing a colored background 1105 behind the group of icons 1000. Any suitable representation of progress indicating a certification may be used.

In some embodiments, the display of the group of icons 1000 may be created or altered based on skill degradation. For example, it may be assumed that as the time since completion of a particular training course elapses, the proficiency of the user in applying the skills taught by the training course decreases. The management module may reflect this skill degradation by removing the colored background 1105, adding a solid outline 915 to each icon, adding a dashed outline to each icon 910, and the like, depending on the elapsed time. For example, if six to nine months have passed since completion of the particular training course, the colored background 1105 may be removed and a solid outline 915 may be added to each icon, and if nine to twelve months have passed since completion, the solid outlines 915 may be replaced by dashed outlines 910. For further example, degradation of skill may be represented by adding visual cracks and/or other indicators of deterioration to the group of icons 1000.

In some embodiments, the management module may facilitate the user altering the representation of progress. In an exemplary embodiment, the management module may be configured to provide a sliding bar that a user can move in relation to the representation of progress. For example, referring again to FIG. 10, a slider bar 1010 may be moved by a user. The group of icons 1000 may be displayed differently on one side of the slider bar 1010 compared to the other side of the slider bar 1010. For example, the icons 905, 1022, 1020 on the left side of the slider bar may be displayed to represent the desired goal of the particular training material 322 associated with the group of icons 1000, and the icons 1024, 1026, 1028 on the right side of the slider bar may be displayed to represent the actual progress of a user through the training material 322. For further example, if the slider bar 1010 is moved all the way to the right side of the group of icons 1000, one or more icons 1026 that are not yet shown may be displayed. Other methods of altering the display to show actual progress versus goal may be used.

The representation of progress may comprise more than one group of icons 1000. For example, the representation of progress may display the progress of a user through multiple topics, wherein each topic may be taught through multiple training courses. As described, a group of icons 1000 may represent the progress through a training course. Consequently, one or more groups of icons 1000 may correspond to the same topic. The management module may arrange the groups of icons 1000 corresponding to the same topic together and apart from groups of icons 1000 corresponding to different topics. The management module may represent degradation of skill independently for each group of icons 1000, or collectively for the one or more groups of icons 1000 corresponding to the same topic.

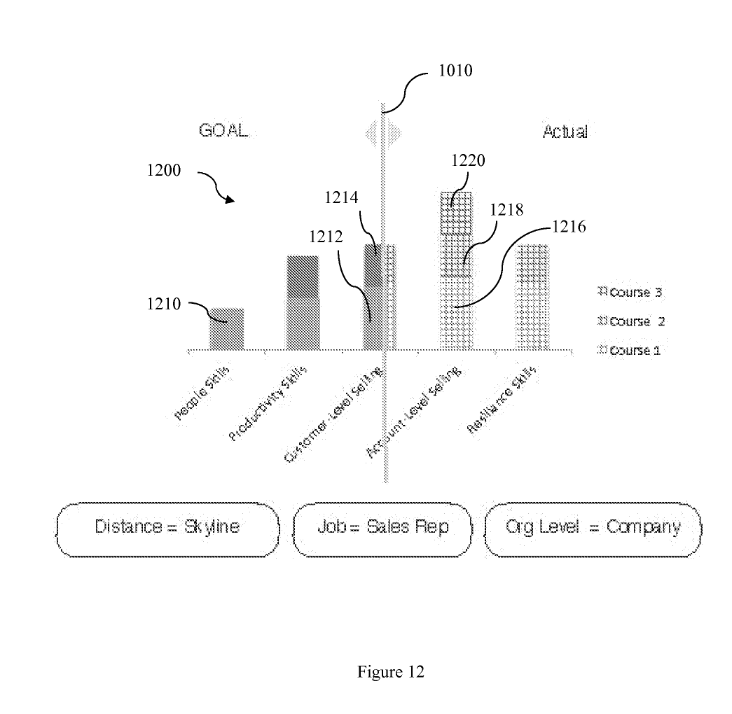

For example, referring to FIG. 12, the representation of progress may show a user's progress through one or more topics, such as “People Skills,” “Productivity Skills,” “Customer-Level Selling,” “Account-Level Selling,” and “Resiliance Skills.” The topics may be taught by one or more training courses, wherein each training course may be represented by a group of icons 1210, 1212, 1214, 1216, 1218, 1220 (collectively 1200). The management module may arrange one or more groups of icons 1000 corresponding to the same topic in a vertical stack representing a building, and may place the first training course on the bottom of the stack, the second training course above the first, and so on. The management module may arrange the one or more topics to represent a skyline.

For example, referring again to FIG. 12, a topic “Account-Level Selling” may be taught by a total of three training courses. Because each training course is associated with a group of icons 1000, the “Account-Level Selling” topic is associated with three groups of icons 1216, 1218, 1220, and the management module may arrange the three groups of icons 1216, 1218, 1220 together, with the first course on bottom and the third course on top.

The management module may create or change the representation of progress according to one or more user inputs and/or user-selectable options. In an exemplary embodiment, the management module may display the representation of progress based on a job type selectable by a user. A job type may comprise any suitable categorization of a user's function within an organization, such as a sales representative, sales manager, sales director, VP of sales, marketing manager, marketing director, VP of marketing, manager of business operations, director of operations, and the like. For example, the job of a sales representative may comprise the topics “People Skills,” “Productivity Skills,” “Customer-Level Selling,” “Account-Level Selling,” and “Resiliance Skills,” while the job of a manager may comprise more management-related topics. In this embodiment, creating or changing the representation of progress may comprise displaying the topics according to a selected job type.

In an exemplary embodiment, the management module may display the representation of progress based on an organizational level, such as an individual, team, district, region, entire company, and the like. In this embodiment, changing the org level may not cause the management module to change the number of topics displayed or the number of training courses per topic, but may cause the management module to create or alter the display of icons based on the progress for the selected organizational level. For example, a particular user may have been certified for a particular training course, but the user's team may only be partially complete with the training course. The management module may display a colored background behind the group of icons 1000 corresponding to the course when the organizational level equal to that particular user is selected, but may display lower levels of progress when the organizational level equal to the user's team is selected. The management module may therefore display a representation of progress not just for a single user, but for any organizational level or other grouping of users.

When representing the progress based on an organizational level comprising more than one user, the management module may display the associated icon and/or group of icons 1000 according to a measure of the progress of the more than one user. In one embodiment, the measure of progress of the more than one user may comprise the percentage of the more than one users that have attained a predetermined threshold of progress. For example, if at least 80% of the more than one users have applied the skill associated with an icon correctly a medium percentage of the time, such as 30% to 59%, the icon may be displayed with a medium level of opacity, such as 50%. For further example, if at least 80% of the more than one users have applied the skills associated with the icons in a group of icons 1000 at least a medium percentage of the time, the icons may be displayed with a medium level of opacity. In one embodiment, the measure of progress of the more than one user may comprise a cumulative percentage of the progress of the more than one users. For example, if the more than one users have applied the skill associated with an icon correctly a combined average of 50% of the time, the icon may be displayed with an opacity of 50%.

In an exemplary embodiment, the management module may display the representation of progress based on a user-selectable view distance. In an exemplary embodiment, a user may select a view distance of the skyline, the topic, course, or skill. For example, if a user selects the view distance of a skill, the management module may display the icon associated with the selected skill. The display of the icon may visually represent a room in a building. If a user selects the view distance of a course, the management module may display a single group of icons 1000 corresponding to the selected course. The group of icons 1000 corresponding to a course may visually suggest a portion of, a set of floors of, or an entire a building.

If a user selects the view distance of a topic, the management module may display the one or more groups of icons 1000 corresponding to the chosen topic. The one or more groups of icons 1000 may visually suggest a building. If a user selects the view distance of the skyline, the management module may display all or a subset of topics, including the groups of icons 1000 corresponding to the displayed topics. Each displayed topic may visually suggest a building, and the one or more buildings may suggest a skyline. The various view distances may be selected in any suitable manner, such as by activating a button, using a pull-down menu, using a pinch-to-zoom operation on a touchscreen device, and the like.

Accordingly, the management module may be configured to represent the progress of a single user or multiple users, at any organizational level, and for any view distance. The management module may facilitate the comprehension of the progress of any desired grouping of users, skills, training courses, topics, job types, organizational levels, and the like.

In some embodiments, one or more of the components of the representation of progress may comprise an interactive link to a detailed breakdown of the data used to generate the displayed value. For example, the user may be able to select a given topic and be presented with the representation of progress for that topic. Similarly, the user may then select a particular group of icons 1000 in the topic and be presented with the representation of progress for the corresponding training course. Similarly, the user may be able to select an icon in a group of icons 100 and be presented with detailed information about the progress for the associated skill for each individual, team, regions, district, division, and the like. For example, if the user is viewing the representation of progress at the organizational level of a team, the user may select the coffee mug icon 905 and may be presented with detailed information regarding the progress of each team member for the associated skill of creating a task list at the beginning of the week.

The training system may further comprise a summary module adapted to present training effectiveness. For example, the summary module may provide analytical results for comparing how well an individual performs their job after completing a given training program or series of training programs. Alternatively, the summary module may be adapted provide results visually in the form of a chart correlating real-world results with successful practice repetitions and/or progress by an individual or group. In one embodiment, the summary module may display a chart correlating an individual's sales results along a first axis against an individual's number of successful practice repetitions and/or progress along a second axis. In another embodiment, the summary module may display a chart correlating an individual's sales results along a first axis against an individual's number of completed training programs and/or progress along a second axis.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A method of training a user by a computer having a memory, comprising:
retrieving a training material corresponding to a training course stored in memory, wherein the training material comprises one or more icons, and each of the one or more icons represents an intended skill to develop;
administering the training material to the user in conjunction with the one or more icons;
tracking a progress of the user through the training material; and
representing the tracked progress using the one or more icons.

2. A method of training a user according to claim 1, wherein administering the training material comprises presenting an interactive feature to the user.

3. A method of training a user according to claim 2, wherein the interactive feature comprises an interactive comment tool.

4. A method of training a user according to claim 1, wherein representing the tracked progress using the one or more icons comprises:
visually grouping the one or more icons together; and
displaying each of the one or more icons based on the tracked progress.

5. A method of training a user according to claim 4, wherein:
tracking a progress of the user through the training material comprises tracking a progress of the user through a plurality of training material corresponding to a plurality of training courses; and
visually grouping the one or more icons comprises displaying a plurality of groups of icons, wherein each of the plurality of groups of icons corresponds to one of the plurality of training courses.

6. A method according to claim 1, further comprising:
changing the representation of the tracked progress based on a position of a movable slider, wherein the representation of the tracked progress on a first side of the slider represents a fully completed training course.

7. A computer system comprising a processor, and a memory responsive to the processor, wherein the memory stores a testing program configured to cause the processor to:
retrieve a training material corresponding to a training course stored in the memory, wherein the training material comprises one or more icons, and each of the one or more icons represents an intended skill to develop;
administer the training material to the user in conjunction with the one or more icons;
track a progress of the user through the training material; and
represent the tracked progress using the one or more icons to be displayed.

8. A computer system according to claim 7, wherein administering the training material comprises presenting an interactive feature to the user.

9. A computer system according to claim 8, wherein the interactive feature comprises an interactive comment tool.

10. A computer system according to claim 7, wherein representing the tracked progress using the one or more icons comprises:
visually grouping the one or more icons together; and
displaying each of the one or more icons based on the tracked progress.

11. A computer system according to claim 10, wherein:
tracking a progress of the user through the training material comprises tracking a progress of the user through a plurality of training material corresponding to a plurality of training courses; and
visually grouping the one or more icons comprises displaying a plurality of groups of icons, wherein each of the plurality of groups of icons corresponds to one of the plurality of training courses.

12. A computer system according to claim 7, wherein the testing program is further configured to cause the processor to change the representation of the tracked progress based on a position of a movable slider, wherein the representation of the tracked progress on a first side of the slider represents a fully completed training course.

13. A non-transitory computer-readable medium storing computer-executable instructions for training a user, wherein the instructions are configured to cause a computer to:
retrieve a training material corresponding to a training course from the memory, wherein the training material comprises one or more icons, and each of the one or more icons represents an intended skill to develop;
administer the training material to the user in conjunction with one or more icons;
track a progress of the user through the training material; and
represent the tracked progress using the one or more icons.

14. A non-transitory computer-readable medium according to claim 13, wherein administering the training material comprises presenting an interactive feature to the user.

15. A non-transitory computer-readable medium according to claim 14, wherein the interactive feature comprises an interactive comment tool.

16. A non-transitory computer-readable medium according to claim 13, wherein representing the tracked progress using the one or more icons comprises:
visually grouping the one or more icons together; and
displaying each of the one or more icons based on the tracked progress.

17. A non-transitory computer-readable medium according to claim 16, wherein:
tracking a progress of the user through the training material comprises tracking a progress of the user through a plurality of training material corresponding to a plurality of training courses; and
visually grouping the one or more icons comprises displaying a plurality of groups of icons, wherein each of the plurality of groups of icons corresponds to one of the plurality of training courses.

18. A non-transitory computer-readable medium according to claim 13, wherein the wherein the instructions are further configured to cause the computer to change the representation of the tracked progress based on a position of a movable slider, wherein the representation of the tracked progress on a first side of the slider represents a fully completed training course.
